(19) United States
(12) Patent Application Publication
(10) Pub. No.: US 2005/0229450 A1
(43) Pub. Date: Oct. 20, 2005

(54) System for wrapping containers

(75) Inventors: Tim Larsen, Minnetonka, MN (US); Michelle Solie, Minneapolis, MN (US)

Correspondence Address: ALTERA LAW GROUP, LLC, 6500 CITY WEST PARKWAY, SUITE 100, MINNEAPOLIS, MN, 55344-7704, US

(73) Assignee: Larsen Design, Minneapolis, MN (US)

(21) Appl. No.: 11/087,258

(22) Filed: Mar. 23, 2005

Related U.S. Application Data
(60) Provisional application No. 60/559,290, filed on Mar. 31, 2004.

(51) Int. Cl. B32B 9/00; B32B 33/00

(52) U.S. Cl. 40/310; 428/40.1; 428/43

(57) ABSTRACT

An attachable wrap for bottles, generally with adhesive on the back side, a decorative or informative design on the front side, and a detachable panel that exposes the original label of the bottle when removed. The wrap optionally has one or more of the following: a detachable card that may optionally be hung from the neck of the bottle, a detachable coupon, a booklet that may optionally be detachable, and a decorative pattern that shows through the wrap. The wraps may be adjustable in size in order to accommodate bottles of varying diameters, by detaching perforated regions along one or more edges, or by stretchable elastic regions or accordion pleats. The wraps may be pre-packaged as a kit. The wraps may also be printable by the user in a sheet-feed printer, and may optionally be packaged with software for manipulating text and pictures, and configuring a printer.

### CROSS-REFERENCES TO RELATED APPLICATIONS

Not Applicable

### BACKGROUND OF THE INVENTION

1. Field of the Invention

The present invention is directed to wrapping of containers for decorative and/or informational purposes.

2. Description of the Related Art

When a gift is given, it is customary to wrap the gift and attach a card. An unwrapped gift may imply that the gift was purchased at the last minute, or may convey insensitivity in that the donor is unwilling to go through the small effort of wrapping the gift. An attached card allows the donor to express a personalized message to the recipient, and also provides a practical way of identifying who gave the gift. There is a long tradition of gift wrapping and cards, and consumers consistently insist on both when giving a gift.

Traditionally, consumers have faced difficulty when the gift is a bottle, such as a wine bottle. Unlike gifts that are rectangular, bottles are generally cylindrical, making them difficult to wrap. In addition, flat gift cards generally do not adhere well to a cylindrical bottle or container. For instance, it is typically quite a challenge to tape a flat card onto a cylindrical bottle, and then the card generally falls off the bottle after only minor handling.

Furthermore, wrapping the bottle may obscure the label. Although that may not pose problems for most products, it is most undesirable for wine or spirits bottles. Alcoholic beverages are often purchased because of a brand name on the label, and the reputation that the particular brand enjoys in the marketplace. Therefore, a wrapping for a wine bottle, in particular a wine bottle that is sold in a pre-wrapped condition, should not obscure the label.

There exists a need for a bottle wrap that (1) is easy to apply, and (2) has a convenient and reliable way to attach a card to the bottle, or can easily be removed without damage to the original label or allows for visibility of that label when unwrapped.

Consider the holiday season, during which many wine manufacturers pre-wrap their bottles in boxes, so that the wines are displayed on the retailer's shelves in boxes. Boxes are bulky, expensive, and generally opaque, so that the labels on the bottles are obscured. It is unacceptable if the customer cannot read the labels while shopping, and the retailer typically unboxes one bottle of each variety so that the customer may read the information on the label, leading to inherent waste in the packaging and therefore, higher costs. An alternative is boxes with windows, but these are even more expensive and lead to higher retail costs. Because wine bottles come in many different sizes, they usually require one particularly sized box for each variety, requiring additional effort to maintain the proper inventory on the boxes, and additional organization in the store to ensure that the bottles and boxes are properly matched. Furthermore, once the holiday season is finished, there is no demand for the seasonal boxes, and a retailer typically has to unbox all of the pre-wrapped bottles and dispose of the boxes, leading to waste in packaging, and ultimately, higher costs.

An alternative wrap for a bottle is a bag. Although less expensive than a box, a bag still has many of the same drawbacks as a box—a different bag is required for each bottle size, and the label on the bottle is obscured. Furthermore, both bags and boxes must have a certain degree of bottom structural integrity to them. A wine bottle may be sitting in a wet environment where the bottom of the bag or box may get wet. The structural integrity of the bag or box may be compromised, and may tear when the bottle is lifted. (Note that a bag is generally lifted by its handles, and a box is generally lifted by its sides.) If the bottle is unintentionally dropped because its wrap is structurally compromised, it could lead to damage to the product, damage to the surroundings, or even injury to the consumer. Therefore, there exists a need for a bottle wrap to replace boxes and bags, which does not obscure the original label on the bottle or is easily removed, has a convenient and reliable way to attach a card to the bottle, all without creating a product liability hazard.

Furthermore, the insulating properties of a bag are fairly ineffective. If a chilled wine bottle, wrapped in a bag, is left at room temperature for an extended period of time, the bag generally does little to keep the wine cold. Likewise, a boxed spirit bottle will not fit in a rapid chiller without damage. There exists a need for a bottle wrap that has insulating properties, does not obscure the original label on the bottle, has a convenient and reliable way to attach a card to the bottle, without creating a product liability hazard.

Additionally, there is an issue of inconvenience with typical bottle packaging. A customer may purchase a typical bottle bag and a gift card separately, often requiring purchases from two separate locations. Items purchased in advance may easily be misplaced. Furthermore, as described above, it is difficult to reliably attach a flat card to a cylindrical bottle. Accordingly, there exists a need for an integral bottle wrap, in which the wrap, a gift card, and an implement for attaching the card to the bottle are all packaged together.

A typical wrapping such as a box or bag is generally removed from the bottle and discarded afterwards, but there could be an important informational purpose of the wrap beyond decoration. As a result, a typical decoration does little to enhance the value of the product.

For example, consider enhancement by providing additional information about a particular variety of wine. A typical wine customer may not know a great deal about wine, and may need extra information in addition to what is printed on the label, such as its characteristic flavor, the particular year of the wine, the history of the vineyard that it is from, and some foods that go nicely with the wine, for instance. A typical bottle bag will certainly not provide any extra information for the customer.

As a further example, consider value enhancement by cross-promotion of products. A manufacturer may wish to promote other items in its product line, or other related products. For example, a wine manufacturer may wish to promote a particular brand of cheese, or a gin manufacturer may wish to provide a coupon for a particular tonic. These examples would enhance the value of the product, but are certainly not addressed by a typical bottle wrap, such as a bag or box. There exists a need for a bottle wrap which enhances the value of the product, and furthermore makes access to the original label easy, has a convenient and reliable way to attach a card to the bottle, and provides an optimal decorative and informational solution without creating a product liability hazard.

### BRIEF SUMMARY OF THE INVENTION

According to one embodiment, a wrap, separate from and capable of being attached to a generally cylindrical container, comprising a stock member having a first edge, a second edge, a front side and a back side, said front side capable of displaying information or decoration or providing insulation to the container, and an adhesive portion applied to said back side, so that when the label is wrapped around the container, the front side is visible and the adhesive portion affixes the back side to the container.

According to another embodiment, a wrap, separate from and capable of being attached to a generally cylindrical container, comprising a stock member having a first edge, a second edge, a front side and a back side, said front side capable of displaying information or decoration or providing insulation to the container, and an adhesive portion applied to said back side, so that when the label is wrapped around the container, the front side is visible and the adhesive portion affixes the back side to the container; said member including a removable portion therein, said portion having an aperture; an attachment filament; whereby said removable portion is independently attached to said container by said filament which passes through said aperture.

According to another embodiment, a wrap kit, separate from and capable of being attached to a generally cylindrical container, comprising at least one stock member having a first edge, a second edge, a front side and a back side, said front side capable of displaying information or decoration or providing insulation to the container, and said member including at least one removable portion attached at an edge of said stock member, said removable portion capable of functioning as a gift card when separated from said stock member.

According to another embodiment, an on demand decorative wrap kit for containers, comprising a plurality of stock members separate from and capable of being attached to a generally cylindrical container, each stock member having a first edge, a second edge, a front side and a back side, said front side capable of displaying information or decoration or providing insulation to the container; and software capable of being executed on a computer for visualizing on a display the layout of said stock member and gift card portion; software for allowing the user to input data onto selected areas of said stock member and gift card and in user selected orientations, so that a user may input data as desired and instruct a printer to imprint said data on a succession of stock members previously stacked in the printer.

### BRIEF DESCRIPTION OF THE SEVERAL VIEWS OF THE DRAWINGS

FIG. 1 illustrates an embodiment of a bottle wrap in accordance with the present invention.

FIG. 2 illustrates a wrap, applied to a wine bottle, which has a removable panel that reveals the original wine bottle label.

FIG. 3 illustrates a wrap before it is applied to a bottle.

FIG. 4 illustrates a wrap with detachable perforated regions along an edge.

FIG. 5 illustrates a wrap with detachable perforated regions and a detachable card.

FIG. 6 illustrates a wrap with accordion pleats.

FIG. 7 illustrates a wrap with accordion pleats and a detachable card.

FIG. 8 illustrates a further wrap with accordion pleats and a detachable card.

FIG. 9 illustrates a wrap with accordion pleats, applied to bottle of various diameters.

FIG. 10 illustrates a wrap with a removable panel, a detachable card, a pair of notches that hold elastic bands, and a display slot.

FIG. 11 illustrates a wrap with a detachable card and a detachable coupon.

FIG. 12 illustrates a wrap with a fold and a label.

FIG. 13 illustrates a wrap with a fold and a label, partially applied to a bottle.

FIG. 14 illustrates a wrap with a fold and a booklet.

FIG. 15 illustrates a wrap with a fold and a booklet, applied to a bottle.

FIG. 16 illustrates a patterned wrap with a detachable card.

FIG. 17 illustrates a patterned wrap with a detachable card, applied to a bottle.

FIG. 18 illustrates a wrap with curved edges.

FIG. 19 illustrates a wrap with curved edges, applied to a bottle.

FIG. 20 illustrates a kit of wraps, joined by a common perforated edge.

FIG. 21 illustrates a bag of wraps.

FIG. 22 illustrates a further embodiment of a wrap.

FIG. 23 illustrates a further embodiment of a wrap, applied to a bottle.

FIG. 24 illustrates a wrap with multiple adhesive strips.

FIG. 25 illustrates a series of detachable decorations, removed, and attached to the base of wine glasses.

FIG. 26 illustrates a wrap with detachable perforated regions along two edges.

### DETAILED DESCRIPTION OF THE INVENTION

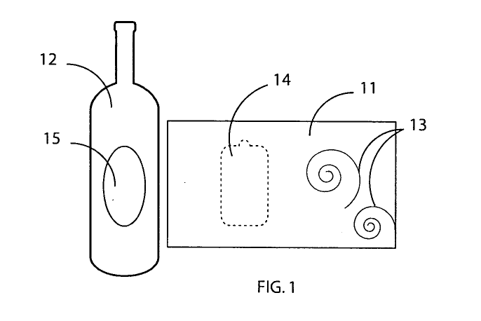

An exemplary wrap 11 is shown in FIG. 1, before it is affixed to a bottle 12 by a user. The wrap 11 is generally a stock member, paper or plastic, and may have a printed or textured design on its front side 13. Alternately, the wrap 11 may be made of an insulating material, such as cardboard, foam, or plastic. Alternately, the wrap 11 may be largely blank or have designs on only certain portions of the wrap 11, and may be capable of being fed through a sheet-feed printer for on demand custom printing of information or decoration. The wrap 11 may contain a decorative or informative design on its front side 13, which is visible to the user when it is affixed to the bottle 12. The wrap 11 may contain a removable panel 14, which reveals the original label 15 of the bottle 12 when removed. The removable panel 14 is made detachable along a detachment line by a method well-known in the art, such as die-cuts, score lines, perforations, or by a pre-applied, removable adhesive. Once the panel 14 is removed, the original label 15 may be visible either through a hole in the wrap 11, or through a largely transparent backing layer contained in the wrap 11. One use of the detached portion 14 is an indicator such as a greeting card, coupon, advertisement or the like.

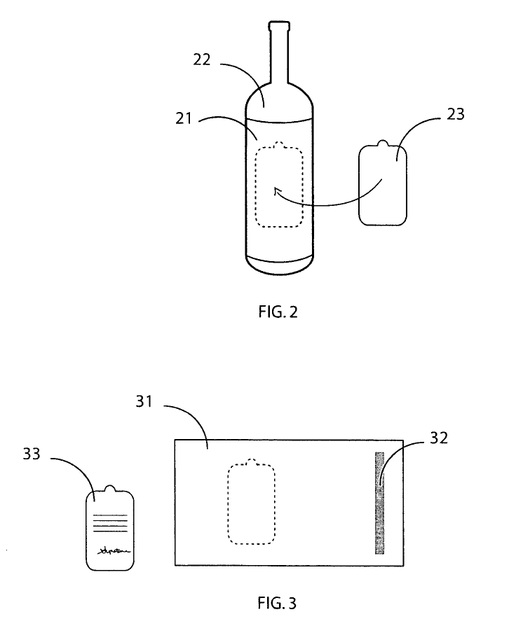

FIG. 2 shows a wrap 21 after it is applied to a wine bottle 22. A removable panel 23 may be removed by the user to reveal the original label on the wine bottle 22 and may optionally serve as a hang tag gift/card greeting.

FIG. 3 shows a wrap 31 before it is affixed to a bottle or cylindrical container. The shape of the wrap 31 may be generally rectangular, so that the surface area of the bottle is largely covered by the wrap 31, excluding the neck of the bottle. In the circumferential direction, the wrap 31 may preferably be slightly larger than the circumference of the bottle, so that a portion of the wrap 31 overlaps itself and may be used to affix the wrap 31 to itself, in addition to the surface of the bottle. FIG. 3 shows a strip of adhesive 32, located adjacent to an edge of the wrap 31, that is used to fasten the wrap 31 to itself when the wrap 31 is applied to a bottle. Practically, only one strip 32 is required but two or more strips may be used to ensure that the wrap will not slip off the bottle when lifted.

The adhesive 32 used on the wrap 31 may preferably be a pressure-sensitive adhesive wax or other binder, with a non-adhesive backing strip that may be peeled away by the user prior to use. The wrap 31 may use one or more strips of adhesive 32, each preferably located adjacent to an edge of the wrap 31, such as vertically as shown or horizontally. Horizontal glue lines provide a superior circumferential attachment to the bottle, which may be critical if the bottle is wet from condensation. Horizontal strips (or diagonal) provide a greater likelihood of some adhesion to parts of the bottle that are dry.

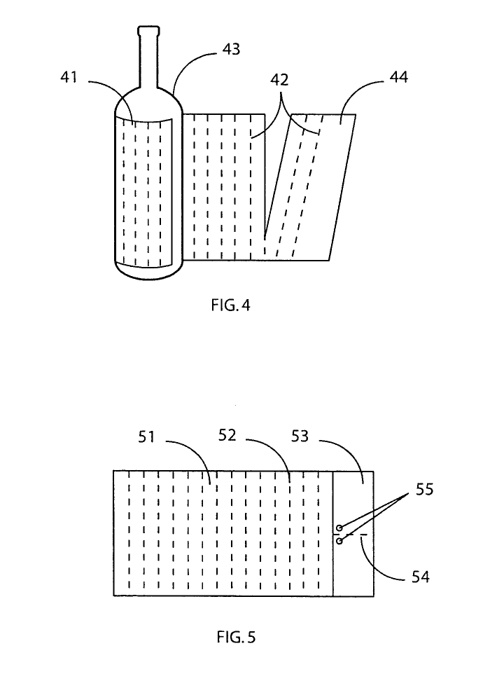

The removable panel 33 may serve an additional function once it is removed from the wrap 31. For example, it may contain a gift card on the front or back of the panel, optionally with appropriate printing and room for an inscription by the user. The removable panel 33 may also contain a coupon for a service or for merchandise. The removable panel 33 may also contain an identification tag or a greeting tag, preferably hung around the neck of the bottle through a hole in the panel. The removable panel 33 may also contain information about the contents of the bottle, such as the details of a particular wine, for example. The removable panel 33 may be divided into separate regions, with a different function for each region. For example, a panel 33 may have a greeting card in one region, and a coupon in another. The regions may be detached from each other by perforations, for example, or by a similar method well-known in the art. Additionally, there may be more than one removable panel 33 on the wrap 31. The different configurations for the removable panel 33 are further described in more detail in FIGS. 4-22.

In order to accommodate various sized (circumference) bottles, a wrap may have features that can alter its size. For example, FIG. 4 shows a wrap 41 that has detachable perforated regions 42 throughout the wrap 41, which may be removed by the user in order to fully surround a small diameter bottle 43. Alternatively, the perforated regions 42 may be located along only one edge, or along both edges but not necessarily throughout the wrap 41. In this configuration, horizontal or diagonal glue lines are preferred. A removable card 44 is detachable from the wrap 41. Note that the wrap shown in FIG. 4 can accommodate a container of lesser circumference with less overlap of the stock member.

FIG. 5 shows a wrap 51 with detachable perforated regions 52, before it is affixed to a bottle. The wrap 51 contains a detachable card 53, which preferably has a fold line 54 and a pair of holes 55 equally spaced from the fold line so that the card may be suspended by a string, filament, or elastic band laced through the holes 55 (see for example FIG. 9). Alternatively, the card 53 may have no holes 55 or several holes 55. As a further alternative, the card may have no fold line 54 or multiple fold lines 54 to make an accordion pamphlet. It will be understood that all of the cards shown in further figures may have no holes, one hole, or multiple holes, as well as no fold line, one fold line, or multiple fold lines.

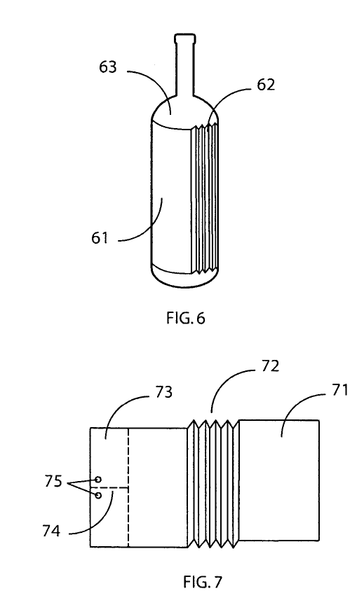

FIG. 6 shows an alternate to detachable perforated regions, in which the wrap 61 has elastic or accordion pleats 62, so that the wrap 61 may be stretched to fit around large diameter bottles 63. The pleats 62 may be made from an elastic material or a stretchable plastic material, and may form an expansion section. In the case of accordion materials, the preferred configuration has the pleats on the rear part of the wrap. The wrap may be corrugated, with flutes oriented vertically when applied.

FIG. 7 shows a wrap 71 that has elastic or accordion pleats 72 in one particular region of the wrap. Alternatively, the accordion pleats 72 may extend throughout the wrap 71, or exist in various unconnected regions in the wrap 71. A detachable card 73 is shown in FIG. 7, with a fold line 74 and a pair of holes 75 for an attachment cord or band.

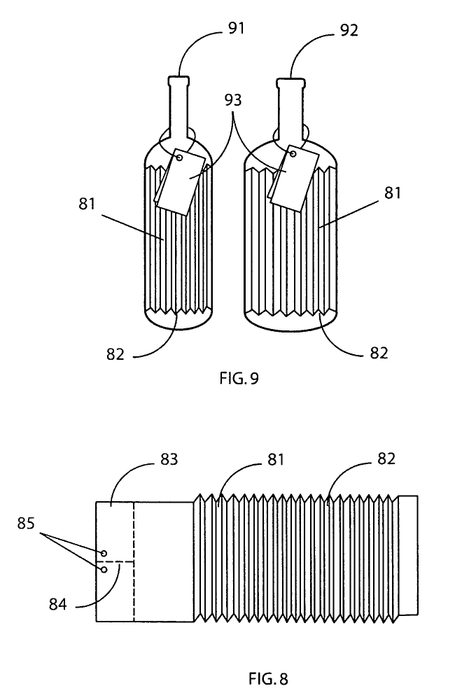

FIG. 8 shows a wrap 81, with accordion pleats 82 that extend over a larger extent of the wrap 81 than the wrap 71 shown in FIG. 7. The wrap has a detachable card 83 that has a fold line 84 and a pair of holes 85. FIG. 9 shows the wrap 81, after it is applied to two bottles 91 and 92 that have different diameters. The accordion pleats 82 are stretched farther apart for the bottle 92 with the larger diameter, demonstrating that the same wrap 81 may accommodate different sized bottles 91 and 92. Similarly, a stretchable elastic or plastic material may be used instead of, or in addition to, accordion pleats 82. Each detached greeting card 93 is folded along its fold line and suspended from a pair of holes.

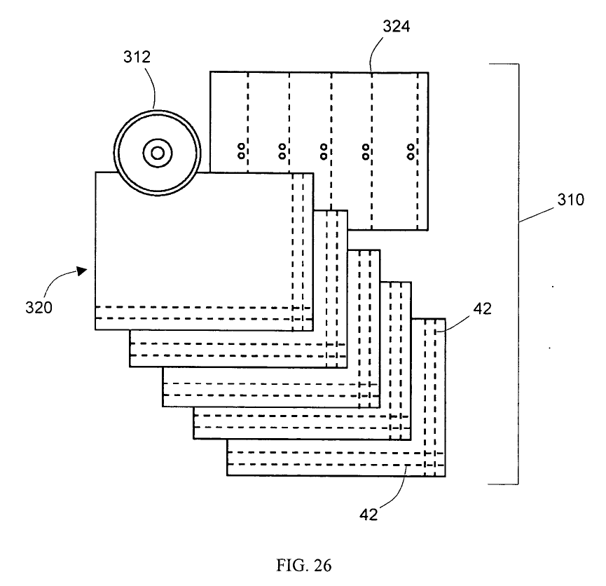

Alternatively, the wrap may contain detachable perforated regions oriented perpendicular to the regions shown in FIGS. 4 and 5, in order to accommodate bottles of different heights and circumferences in a single product, as shown in FIG. 26.

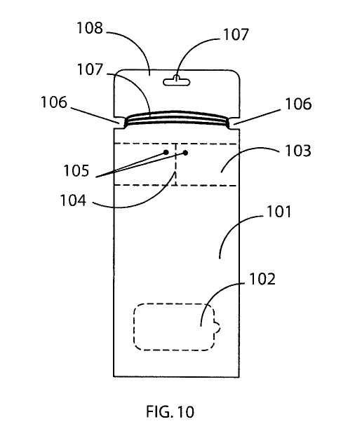

The wrap may also be deliberately oversized, with removable features such as gift cards, coupons, booklets, identification tags, and devices used for display of the wraps in stores. FIG. 10 shows an exemplary wrap 101 that has several detachable features. In addition to the removable panel 102 that reveals the original label of the bottle, the wrap 101 has a detachable card 103 with a fold line 104 and a pair of holes 105. Furthermore, the wrap 101 has a pair of notches 106, around which a series of elastic bands 107 may be hung. The portion with the pair of spaced apart notches may be referred to as a hang tag card. The elastic bands 107 may be removed by the user, and used to hang cards 103 or tags from the neck of the bottle, or around the bases of various wine glasses, for example. Alternatively, the wrap 101 may have various combinations of notches 106 that may hold different types of elastic bands 106, for example. The wrap 101 may have a display slot 107, which supports the wrap 101 in a store display. Alternatively, the wrap 101 may have various display slots 107, which may have different sizes and locations on the wrap 101. The notches 106 and the display slot 107 are contained in a removable portion 108 that may be discarded by the user. Alternatively, the removable portion may contain product information or coupons that may be of use to the user, but are not typically kept with the wrap 101 on a bottle or on wine glasses.

Although not shown in FIG. 10, a removable feature may be a booklet (such as an accordion fold) instead of a card 103. The booklet, or multipage book portion may be decorative in nature. Alternatively, the book may be informative in nature, and may provide information such as the vineyard, the history of wine, or a series of recipes that go well with the wine, for instance. Alternatively, the booklet may be a note pad or a shopping list. Alternatively, the booklet may be related to the particular topic shown on the wrap 101. For example, if the wrap portrays a work of art by a particular artist, the booklet may provide information about the artist's other work. If the wrap 101 is part of a collectible series, say of works by a particular artist, then the booklet may provide details about the series and how to purchase prints thereof.

Any of the removable features shown in FIG. 10 may be detached by perforations, for instance, and may be detached either before or after the wrap is affixed to the bottle.

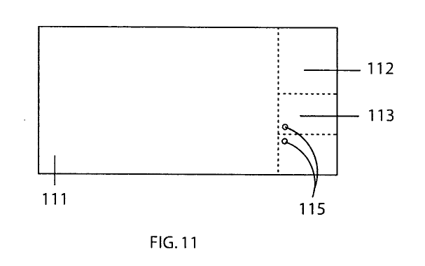

FIG. 11 shows a wrap 111 that has a coupon 112 and a card 113. The card has a fold line and a pair of holes 115. Both the coupon 112 and the card 113 are typically detached from the wrap 111, either before or after the wrap 101 is affixed to a bottle. Alternatively, the wrap 111 may contain additional detachable items that may be of use to the user, and may not necessarily be attached to the bottle.

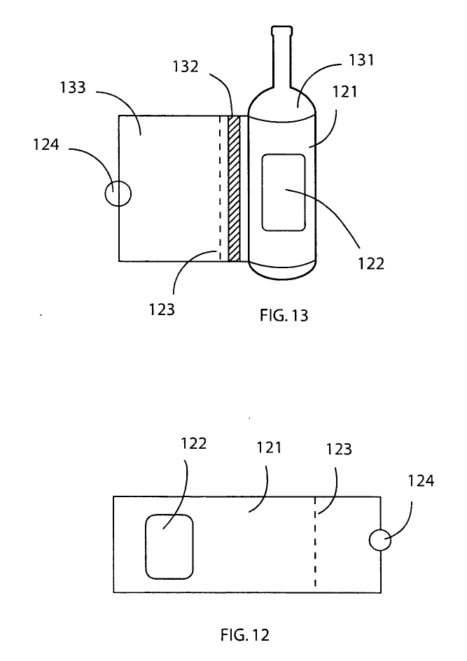

FIG. 12 shows a wrap 121 that has a window 122, a fold line 123 and a label 124. The label 124 may be decorative in nature, with an attractive design on its front surface and a removable adhesive on its back surface. Alternatively, the label 124 may be clear or may serve mostly an adhesive function, rather than a decorative one, and may be referred to as a sealing strip. FIG. 13 shows the wrap 121 of FIG. 12, partially affixed to a bottle 131. When the wrap 121 is fully applied to the bottle 131, it wraps completely around the bottle and is affixed by an adhesive strip 132 (shown but not yet attached in FIG. 13), then further surrounds the bottle past the fold line 123. One end of the wrap is removably affixed by the label 124. The user detaches the label 124 and unfolds a portion 133 of the wrap 121 between the label 124 and the fold line 123, to reveal the original label of the bottle 131, seen through the window 122. Alternatively, the window 122 may be absent, or may be replaced with a detachable card or coupon that is peeled off by the user, perhaps to reveal the original label of the bottle 131. The window 122 may also be replaced with a card that may be hung from the neck of the bottle, or with a series of cards or tags that may be hung from the bases of various wine glasses. Portion 133 also provides space on its inner surface for coupons, serving suggestions, informative aspects of the product, etc.

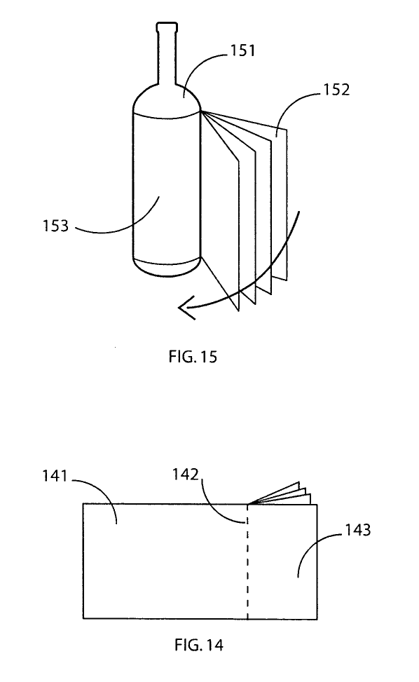

FIG. 14 shows a wrap 141 that has a fold line 142 and an attached booklet 143. When attached to a bottle 151, the wrap 153 and booklet 152 are both affixed to the bottle, and the various pages of the booklet 152 may all be read after the wrap 153 is attached similar to portion 133 but with more writing real estate. Alternatively, the booklet may contain a detachable label, similar to 124, that can keep the booklet 152 closed. Alternatively, the booklet 143 may be a detachable series of name tag cards, and may be hung from the neck of the bottle and/or from wine glasses to identify the name of a wine, such as at a wine tasting.

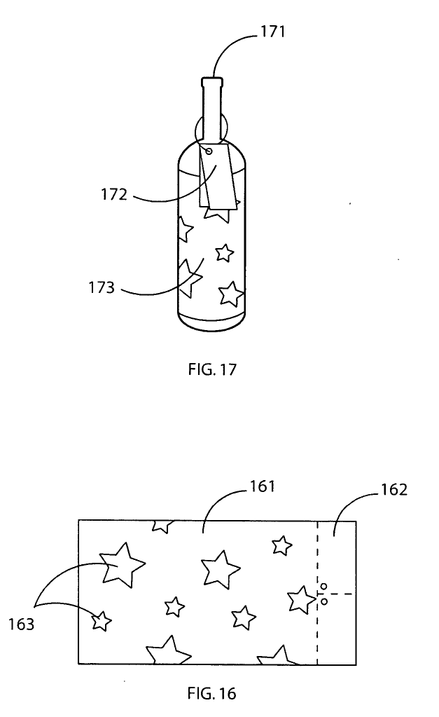

The wrap may contain decorative patterns or decorative voids that allow visibility through the material of the wrap (as opposed to patterns that are printed on the wrap surface). For instance, an exemplary star pattern is shown in FIG. 16. The star pattern may be holes of any shape in the wrap 161, or may be of a transparent or translucent material, so that the bottle may be partially visible through the pattern. The wrap 161 also has a detachable card 162.

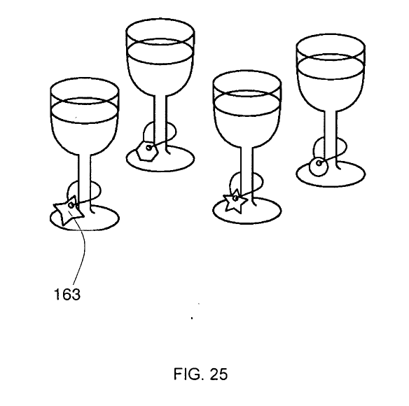

Alternatively, the stars 163 of FIG. 16 may be removable by the user and serve an additional function. For instance, the stars 163 may have perforated lines but are not removed in advance to allow for smooth passage through an on demand printer. For example, the stars 163 may used to associate a group of wine glasses with a particular bottle, where each star 163 may be hung around the base of a wine glass to identify the particular type of wine it contains. Alternatively, the removable features in FIG. 16 may all be deliberately different in color or shape, and each shape 163 may be hung from the base of a wine glass to identify the owner of the glass, rather than the contents of the glass (see FIG. 25). It will be apparent that the design of FIG. 16 is merely exemplary, and that various shapes, colors, sizes, and printed patterns may all be used to form a decorative pattern through the material of the wrap 161. Additionally, a decorative pattern may contain more than one shape or size feature, such as both big stars and little stars, or both stars and circles, for example.

FIG. 17 shows the patterned wrap 173 after it is affixed to a bottle 171. The card 172 is hung around the neck of the bottle 171.

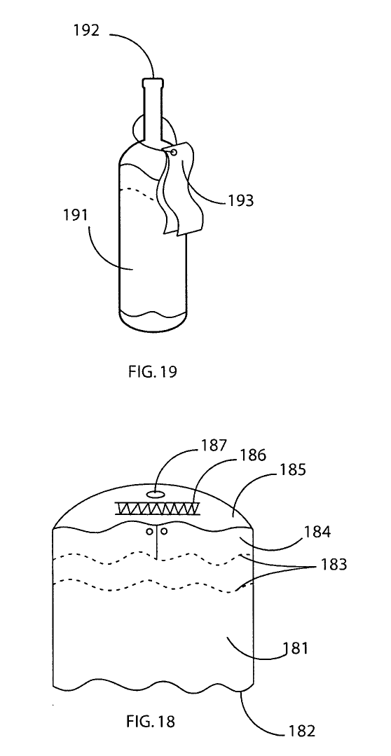

FIG. 18 shows a wrap 181 that has curved edges 182 and curved perforations 183. The curves may be decorative in nature, or may help the wrap to fit an oddly-shaped bottle. The curves may be periodic wave forms such as sinusoidal sawtooth etc., may be random patterns or depictions of natural patterns such as ocean waves, cloud formations, etc. The wrap 181 has a detachable card 184, and a detachable portion 185 that may contain product information 186 and a display slot 187. FIG. 19 shows the curved wavy wrap 191 after it is attached to a bottle 192. The card 193, hung from the neck of the bottle 192, is also curved but not necessarily to match the curves of the wrap 191.

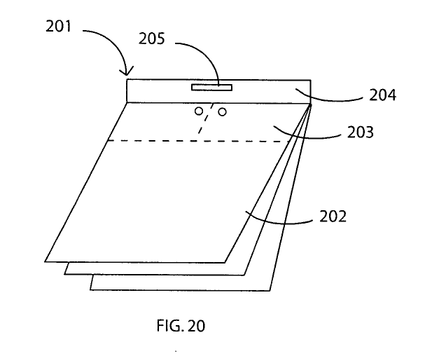

FIG. 20 shows a packet or kit 201 of wraps 202 that may be sold as a set. Each wrap 202 may have a detachable card 203 or other detachable features as described above. The wraps 202 are all joined by a common detachable element 204, which may preferably contain a display slot 205 and product information. Each wrap 202 in the set may be identical, or may be different patterns or surface designs. For example, the packet 201 may feature a series of paintings by a common artist, with a different painting on each wrap 202.

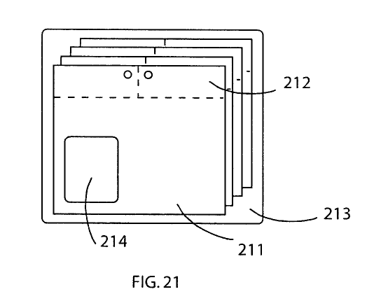

An alternative way of packaging the wraps as a set is shown in FIG. 21. A set of wraps 211, each shown preferably with a card 212, is contained in a largely clear envelope or bag 213, along with optional ribbons or rubber bands. A customized label 214 may be used to identify the set, and may further be customized with particular store information or bar codes, for example. Furthermore, a detachable coupon may also be placed on the bag 213, which may be preferably customized for each store.

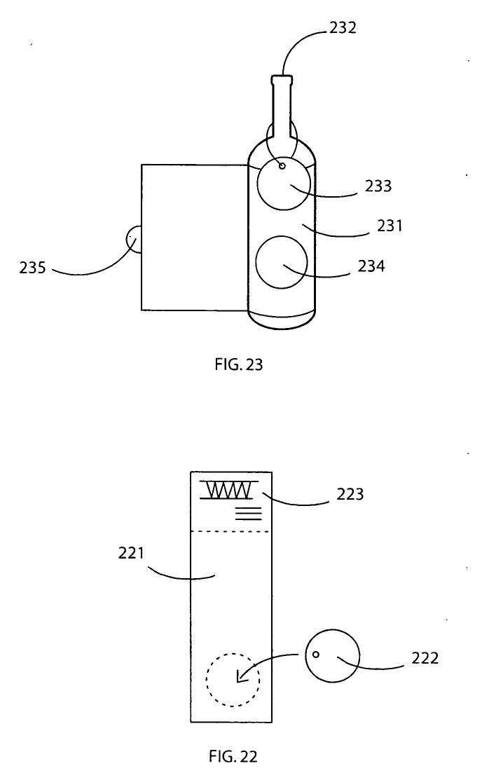

FIG. 22 shows a wrap 221, in which the removable panel 222 may be hung from the neck of the bottle as a greeting card or an identification tag. The wrap 221 also contains a removable section 223 with text and product information. FIG. 23 shows a wrap 231 applied to a bottle 232, in which the panel 233 is removed from the window 234 and hung from the neck of the bottle 232. The wrap may be removably folded over the label, and removably affixed with a label 235.

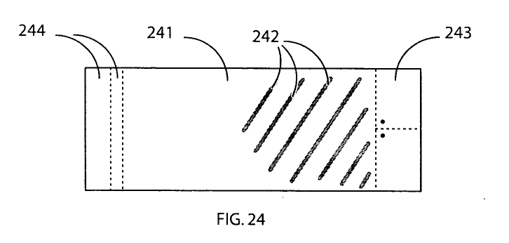

Although FIG. 3 shows a thin strip of adhesive 32 generally adjacent to an edge of the wrap, various other adhesion schemes may be used. FIG. 24 shows a wrap 241 with multiple adhesive strips 242. The strips 242 are drawn with a regular spacing and oriented along a diagonal, but it will be appreciated that any number of strips may be used, with any orientation. Less preferably, the entire back surface of the wrap may be coated with an adhesive, although this is presumably more expensive than applying the adhesive in strips. The wrap 241 also has a removable card 243, and removable strips 244 that may be used to adjust the wrap for different sized bottles.

As shown in FIG. 26, in another embodiment of the present invention, the wraps may be sold as a kit 310 of wraps and software 312 for imprinting on demand and assembled by the user. Each wrap in a package may be capable of being fed through a sheet-feed printer. The blank wraps 320 may be largely rectangular in shape, in order to be compatible with the printer, and may have a non-adhesive backing layer on the stock member portion such as 202 in FIG. 20, but preferably not on the card portion 203. Greeting cards or “indicia” 324 may likewise be supplied for separate imprinting or as integral and removeable as in prior embodiments in this application, in the later case, all elements can be imprinted simultaneously. The blank wraps may optionally have one or more fold lines or split lines 42, so that after the blank wraps are fed through a printer, they may be resized or folded as necessary. The kit may include software 312 that allows the user to customize the printing configuration, and may allow the user to import and manipulate various images for printing on the wrap. The software may additionally allow the user to supply images for printing on the wrap, in addition to optionally providing a catalog of images, or access to a remote catalog of images for printing. Optionally, the software may include a database for wine information, or access to a database at a remote location, so that the user may use the software to print appropriate information where desired.

In a preferable embodiment of the software, a user may first select from a variety of templates, each corresponding to a particular wrap size, to be fed through a sheet-feed printer by the user. In addition to wrap size, the templates may include various formats for the perforated regions, including various sizes, shapes, and configurations. Once the wrap size is selected, the user may be prompted to choose one from a variety of formats, each corresponding to a type of layout, for example, a series of decorative layouts, or a series of informational layouts. The user may then use an array of software drawing tools to compose the visual content of the wrap, displayed representatively on the computer's display. For example, the user may use simple tools to place polygons of desired shapes and sizes at desired locations on the wrap. Once the user has satisfactorily completed a design for a wrap, the user may print the completed wrap on a stock member that is fed through the user's sheet-feed printer. The stock member may have detachable regions for removal after the wrap is printed. Additionally, the wrap may be printable on both sides, such as for the inside of the gift card, and may need to be suitably fed twice through a printer with the software having a second side with templates.

1. A wrap, separate from and capable of being attached to a generally cylindrical container, comprising:
a stock member having a first edge, a second edge, a front side and a back side, said front side capable of displaying information or decoration or providing insulation to the container,
an adhesive portion applied to said back side, so that when the label is wrapped around the container, the front side is visible and the adhesive portion affixes the back side to the container; and
a removable panel in said stock member, said panel being fully detachable therefrom and hangable from said container as an indicator.

2. A wrap according to claim 1, wherein said adhesive portion is applied along the length of the member generally along adjacent said edges.

3. A wrap according to claim 2, wherein said edges are the top and bottom edges of said member.

4. A wrap according to claim 2, wherein said edges are the sides of the member.

5. A wrap according to claim 1, wherein said adhesive portion is applied generally diagonally across said back side.

6. A wrap according to claim 1, further comprising a removable panel distant from said edges, said panel being generally sized to reveal an existing container label when said panel is removed, so that the existing label can be seen though the space created by said removable panel.

7. A wrap according to claim 6, wherein said removable panel further reveals a transparent panel spanning the space revealed by removal of said panel, thereby creating a window in the stock member.

8. A wrap according to claim 6, wherein said removable panel forms a greeting card after removal.

9. A wrap according to claim 6, wherein said removable panel forms a coupon after removal.

10. A wrap according to claim 1, wherein said stock member includes an expansion section.

11. A wrap according to claim 10, wherein said expansion section is corrugated with flutes oriented generally orthogonally to the circumference when said wrap is installed.

12. A wrap according to claim 9, wherein said stock member includes a plurality of removable strips, so that when at least one strip is removed, the wrap can accommodate a container of lesser circumference.

13. A wrap according to claim 1, further including a sealing strip affixed at one edge of said stock member on its front side, so that when said wrap is applied to a container, its edge may be sealed against the container by said strip.

14. A wrap according to claim 1, wherein said stock member includes decorative voids to permit viewing of the container surface at preselected locations.

15. A wrap, separate from and capable of being attached to a generally cylindrical container, comprising:
a stock member having a first edge, a second edge, a front side and a back side, said front side capable of displaying information or decoration or providing insulation to the container, and
an adhesive portion applied to said back side, so that when the label is wrapped around the container, the front side is visible and the adhesive portion affixes the back side to the container;
said member including a removable portion therein, said portion having an aperture;
an attachment filament;
whereby said removable portion is independently reattachable to said container by said filament which passes through said aperture.

16. The wrap according to claim 15, wherein said container is a bottle having a neck portion, and wherein said removable portion is capable of being hung from said neck by said filament after removal.

17. A wrap according to claim 15, wherein said removable portion is separable from said stock members along a detachment line.

18. A wrap according to claim 15, wherein at least one of said edges is removable, so that one dimension of said wrap is reduced to accommodate containers of different circumferences.

19. A wrap according to claim 15, wherein at least one of said edges is removable, so that length of said wrap is reduced to accommodate containers of different circumferences.

20. A wrap according to claim 15, wherein at least one of said edges is removable, so that the height of said wrap is reduced to accommodate containers of different heights.

21. A wrap according to claim 20, wherein said removable edge follows a generally periodic pattern so that when said edge is removed, a new generally periodic edge is exposed.

22. A wrap according to claim 15, wherein said filament includes an elastic band.

23. A wrap according to claim 15, wherein the adhesive portion does not include the removable portion.

24. An imprintable wrap kit capable of simutaneous imprinting of a stock member and an indicator element in a simple pass said kit being separate from and capable of being attached to a generally cylindrical container, comprising:
at least one stock member having a first edge, a second edge, a front side and a back side, said front side capable of displaying information or decoration or providing insulation to the container, and
said member including at least one fully removable portion attached at an edge of said stock member, said removable portion capable of functioning as an indicator card when separated from said stock member.

25. A wrap kit according to claim 24, wherein said removable portion includes an aperture and said wrap kit includes at least one filament capable of being laced through said aperture and around at least a portion of said container so that said gift card may hang therefrom.

26. A wrap kit according to claim 24, wherein said stock member further includes a hang tag card portion attached thereto, and wherein said hang tag card includes a pair of spaced apart notches, said notches configured to receive and hold said filaments on said hang tag card.

27. A wrap kit according to claim 26, wherein said gift card includes a fold line and a pair of apertures equally spaced from said fold line, so that when said indicator element is separated from said stock member and folded along said fold line, said holes will align, allowing said filament to pass therethrough.

28. A wrap kit according to claim 26, further including a plurality of stacked stock members removably affixed to said hang tag card portion.

29. A wrap kit according to claim 24, wherein said stock portion further includes a multipage book portion affixed thereto, so that when said wrap is applied, the book portion extends from said container.

30. A wrap kit according to claim 29, wherein said book portion is detachable from said stock member.

31. A wrap kit according to claim 30, wherein said book portion includes an aperture and said kit includes at least one filament configured to be passed through said aperture, so that said book portion may be hung from a portion of said container.

32. An on demand decorative wrap kit for containers, comprising:
a plurality of stock members separate from and capable of being attached to a generally cylindrical container, each stock member having a first edge, a second edge, a front side and a back side, said front side capable of displaying information or decoration or providing insulation to the container; a detachable indicator element and
software capable of being executed on a computer for visualizing on a display the layout of said stock member and gift card portion;
software for allowing the user to input data onto selected areas of said stock member and gift card and in user selected orientations,
so that a user may input data as desired and instruct a printer to imprint said data on a succession of stock members previously stacked in the printer whereby both said stock member and said indicator element are printed simultaneously.

33. The on demand decorative wrap kit for containers according to claim 32, further comprising:
an adhesive portion applied to said back side, so that when the stock member is wrapped around the container, the front side is visible and the adhesive portion is affixed the back side to the container;
said stock member including a detachment line for removing a gift card portion therein, said gift card portion having a detachment line for removing an aperture;

34. The on demand decorative wrap kit for containers according to claim 33, wherein the adhesive portion does not include the gift card portion.
